(19) United States
(12) Patent Application Publication
(10) Pub. No.: US 2004/0165347 A1
(43) Pub. Date: Aug. 26, 2004

(54) Computer identification system and method

(76) Inventors: Arlen L. Roesner, Fort Collins, CO (US); David W. Mayer, Fort Collins, CO (US); Tom J. Searby, Greeley, CO (US); Ryan Ebert, (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/373,905

(22) Filed: Feb. 24, 2003

(51) Int. Cl. G06F 1/16

(52) U.S. Cl. 361/683

(57) ABSTRACT

A computer identification system comprises an identification member retractable into an internal area of a chassis.

### TECHNICAL FIELD OF THE INVENTION

The present invention relates generally to the field of computer systems and, more particularly, to a computer system identification system and method.

### BACKGROUND OF THE INVENTION

Computer systems generally include an identification tag or label for identifying characteristics associated with the computer system such as a manufacturer or distributor name, part number, serial number, service code or warranty information, or other similar types of identification information. The identification label is generally permanently affixed to the rear of the computer system using rivets, adhesives, or other types of attachment means. Alternatively, the identification label may be retained within a pocket formed in, or disposed on, the rearward plastic housing of the computer system. However, accessing the identification label to acquire the information contained thereon may be difficult.

### SUMMARY OF THE INVENTION

In accordance with one embodiment of the present invention, a computer identification system comprises an identification member retractable into an internal area of a chassis.

### BRIEF DESCRIPTION OF THE DRAWINGS

For a more complete understanding of the present invention and the advantages thereof, reference is now made to the following descriptions taken in connection with the accompanying drawings in which:

FIGS. 1A and 1B are diagrams illustrating an embodiment of a computer identification system in accordance with the present invention;

FIGS. 2A-2C are diagrams illustrating an embodiment of a computer chassis and retractable identification member of the computer identification system of FIGS. 1A and 1B; and

FIGS. 3A and 3B are diagrams illustrating another embodiment of a computer identification system in accordance with the present invention.

### DETAILED DESCRIPTION OF THE DRAWINGS

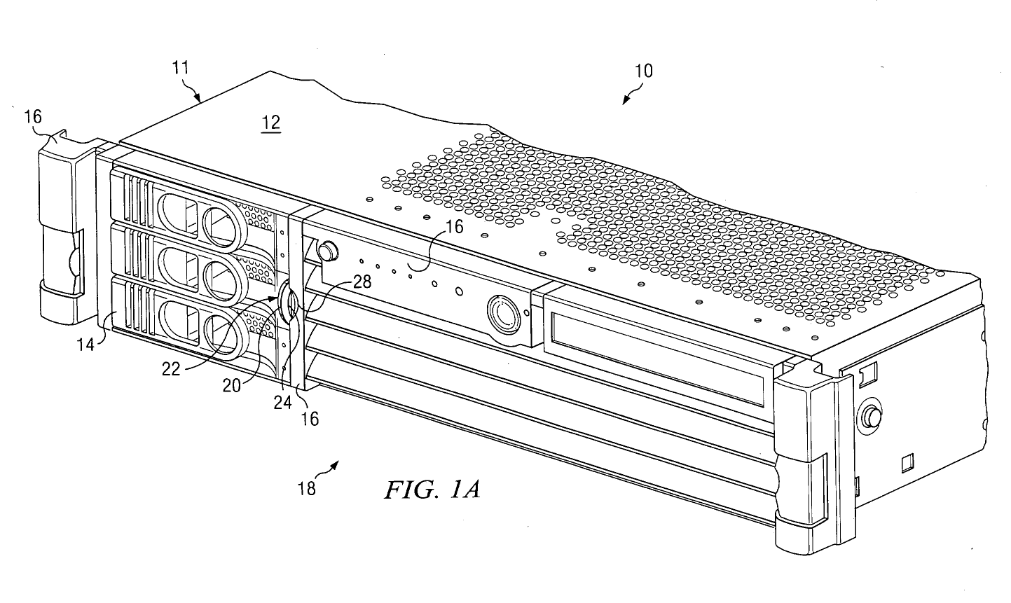

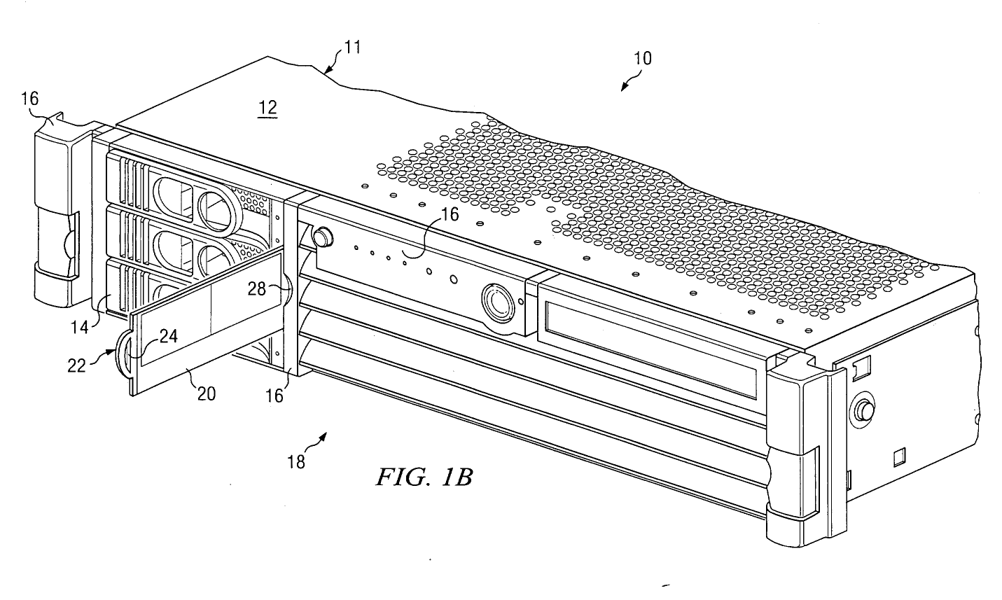

The preferred embodiments of the present invention and the advantages thereof are best understood by referring to FIGS. 1-3 of the drawings, like numerals being used for like and corresponding parts of the various drawings.

FIGS. 1A and 1B are diagrams illustrating an embodiment of a computer identification system 10 in accordance with the present invention. In the illustrated embodiment, system 10 comprises a computer system 11 having a computer chassis 12 for housing various types of computer components such as, but not limited to, printed circuit boards, fan or cooling assemblies, drives 14, or other types of electronic equipment. In FIGS. 1A and 1B, computer system 11 is illustrated as a rack-mounted server assembly; however, it should be understood that computer system 11 may also comprise a desktop computer, laptop computer, workstation, server, or other types of electronic components or computer systems. System 11 may also comprise a bezel(s) 16 coupled to a forwardly-facing or front portion 18 of chassis 12 of computer system 11 to provide cosmetic enhancement or other functional or non-functional aspects to computer system 11. As described herein, the “forwardly-facing” or “front” portion of chassis 12 and/or computer system 11 comprises the portion of chassis 12 and computer system 11 generally accessible by a user to operate the computer system 11 or otherwise perform an activity relating to the general use of the computer system 11. For example, in a desktop or server application, the front portion 18 of the computer system 11 may comprise the portion or area of the computer system 11 generally accessible by the user for loading and/or unloading storage media into a disk drive, interchanging drive modules in a server assembly, or other activities routinely performed relative to the computer system 11.

As illustrated in FIGS. 1A and 1B, computer identification system 10 also comprises a retractable identification member 20 coupled to computer system 11. Referring to FIG. 1A, identification number 20 is illustrated in a retracted position, and in FIG. 1B, identification number 20 is illustrated in an extended position. In operation, identification member 20 comprises information identifying various characteristics of the computer system 11 such as, but not limited to, a manufacturer or distributor of the system 11, regulatory identification numbers, local area network (LAN) identification information, warranty or service tag information, or any other type of information generally associated with the manufacture, distribution, or use of system 11. The identification information may be etched, engraved, adhered, or otherwise attached to identification member 20 such that, preferably, the identification information is not generally alterable.

As illustrated in FIGS. 1A and 1B, identification member 20 comprises a handle 22 for providing engagement of identification number 20 by the user. In the illustrated embodiment, handle 22 comprises a forwardly-extending, arcuately-formed tab 24 adapted for engagement by the user; however, it should be understood that other types of devices may be formed on or affixed to identification member 20 to provide for retractable engagement of identification member 20 by the user. In the illustrated embodiment, system 10 is configured to provide generally perpendicular movement of identification member 20 relative to a plane formed by front portion 18 such that the user may access and/or visually identify the identification information displayed on either side of identification member 20. However, it should be understood that the angular extension angle of identification member 20 relative to the front portion 18 of computer system 11 may be otherwise configured. Additionally, in the embodiment illustrated in FIGS. 1A and 1B, identification member 20 is vertically-oriented relative to a standard operating position or orientation of computer system 11; however, it should also be understood that the position and orientation of identification member 20 relative to computer system 11 may be otherwise configured. Additionally, bezel(s) 16 may be formed having a slot, recess, or other type of opening to accommodate extension and retraction of identification member 20 from front portion 18 of chassis 12. Additionally, bezel(s) 16 may also be configured having a recess 28 to accommodate engagement of identification member 20 by a user while minimizing forward protrusion of identification member 20 beyond a forwardly-facing surface of bezel(s) 16.

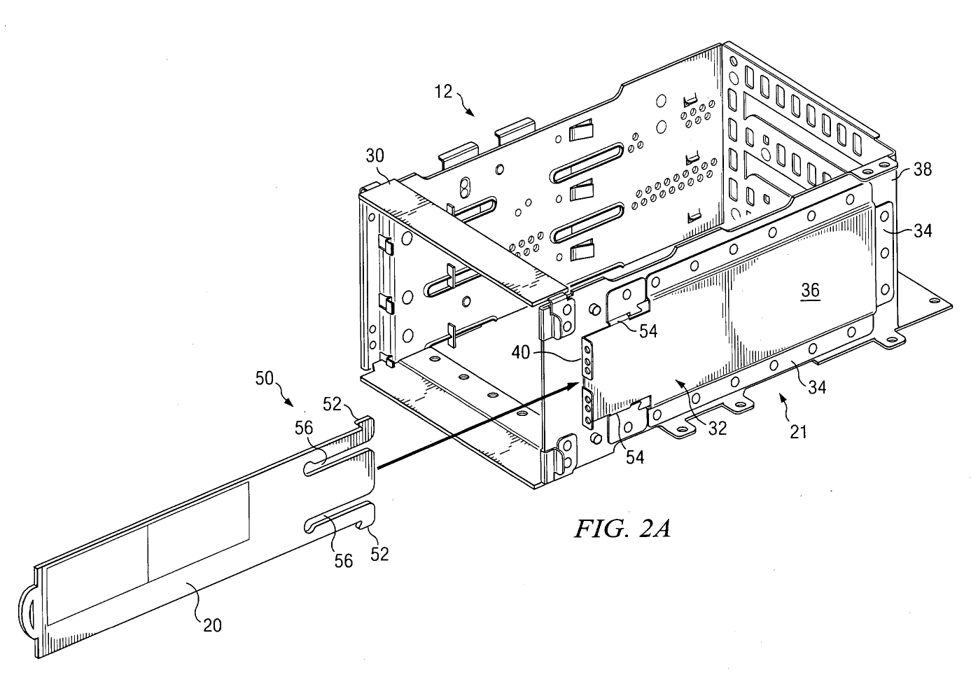

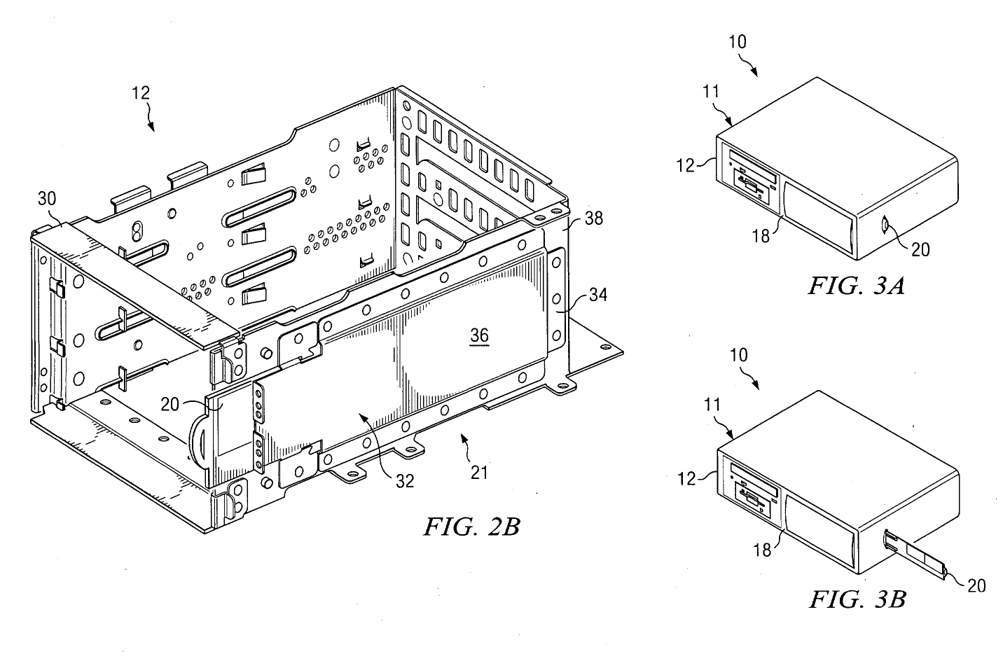

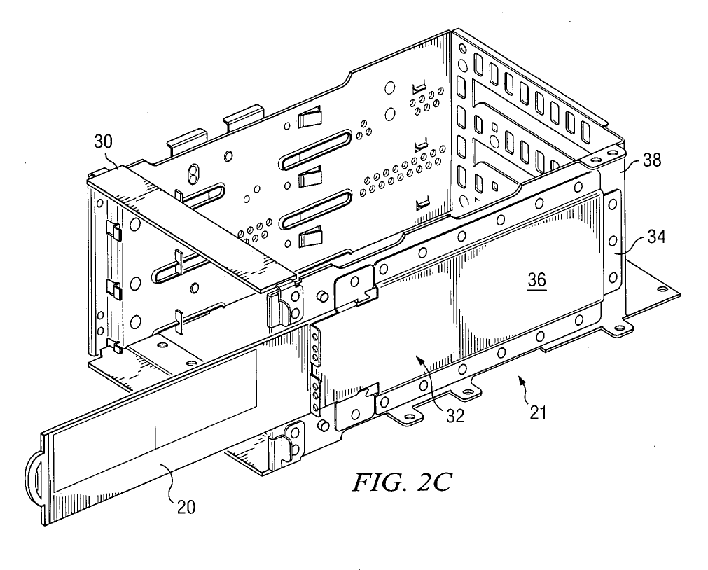

FIGS. 2A-2C are diagrams illustrating an embodiment of identification number 20 disposed within an internal area 21 of computer chassis 12 of FIGS. 1A and 1B. Briefly, FIG. 2A illustrates a drive cage 30 disposed within internal area 21 of chassis 12 prior to installation of identification member 20, FIG. 2B illustrates identification member 20 in a retracted position relative to chassis 12, and FIG. 2C illustrates identification member 20 in an extended position relative to chassis 12. Internal area 21 of chassis comprises an interior portion of chassis generally within the structural walls and/or covers of chassis 12 reserved for hardware components of system 11. For example, in the illustrated embodiment, internal area 21 comprises an internal portion of chassis adjacent to drive cage 30; however, it should be understood that other internal areas of chassis 12 may also be used for identification member 20.

As illustrated in FIGS. 1A-1C, chassis 12 comprises an electomagnetically shielded pocket 32 within internal area 21 adapted for receiving identification member 20. For example, in the illustrated embodiment, pocket 32 is formed from a bracket 34 configured to form a gap or space between a wall 36 of bracket 34 and a wall 38 of drive cage 30 of chassis 12. In some embodiments, bracket 34 is formed of a conductive metal material to provide electromagnetic shielding. In the illustrated embodiment, bracket 34 is formed and coupled to drive cage 30 of chassis 12 to provide a forwardly-facing opening 40 directed toward front portion 18 for receiving identification member 20.

In the illustrated embodiment, computer identification system 10 also comprises a locking element 50 adapted to prevent disengagement or removal of identification member 20 from chassis 12. For example, in this embodiment, locking element 50 comprises a plurality of integral latching elements 52 formed on identification member 20 adapted to engage corresponding bracket portions 54 of bracket 34. For example, as best illustrated in FIG. 2A, identification member 20 comprises a plurality of slots 56 disposed adjacent each locking element 52 such that locking elements 52 may be biased inwardly towards each other during insertion of identification member 20 into opening 40 of pocket 32. Pocket 32 is also configured having a width disposed rearwardly of bracket portions 54 to accommodate the return of locking elements 52 to an unbiased position. Thus, during extension of identification member 20 forwardly from chassis 12, locking elements 52 engage corresponding bracket portions 54 to prevent the removal of identification member 20 from chassis 12. However, it should be understood that other types of mechanisms may be used to prevent removal of identification member 20 from system 11.

In the illustrated embodiment, pocket 32 is formed adjacent drive cage 30 of chassis 12 to utilize an existing wall 38 to form pocket 32. However, it should be understood that pocket 32 may be independently formed and attached to a portion of chassis 12 or pocket 32 may be otherwise formed such that the location of identification member 20 relative to computer system 11 may be configured as desired. Thus, identification member 20 may be positioned at any location, laterally or vertically, relative to chassis 12 to accommodate a desired extension and retraction position.

Thus, the present invention provides a computer identification member 20 that is easily accessible to a user of computer system 11 and is generally unremoveable from the computer system 11. Additionally, the present invention provides an identification member 20 that is accessible while substantially preventing electromagnetic interference leakage from opening 40 for the identification member 20. Further, by providing a retractable identification member 20, the present invention provides for additional cooling of chassis 12 by minimizing the surface area on chassis 12 occupied by identification member 20, thereby enabling additional surface area of chassis 12 to be vented or otherwise configured to provide airflow cooling. For example, prior identification tags are generally secured to rearward portions of the chassis and occupy surface area of the chassis that may be otherwise perforated or vented to allow cooling air to pass through the chassis. The present invention enables additional perforations or vents to be placed in or along the rearward portions of chassis 12 to enhance airflow cooling because, according to one embodiment of the present invention, identification member 20 may be disposed on a front portion of chassis 12. Additionally, because identification member 20 is extendable and retractable relative to chassis 12, the amount of surface area of chassis 12 occupied by identification member 12 is minimal (i.e., the thickness of identification member 20).

FIGS. 3A and 3B are diagrams illustrating another embodiment of computer identification system 10 in accordance with the present invention. In the embodiment illustrated in FIGS. 3A and 3B, system 11 comprises a desktop computer. In FIG. 3A, identification member 20 is illustrated in a retracted position relative to chassis 12, and in FIG. 3B, identification member 20 is illustrated in an extended position relative to chassis 12. A illustrated in FIGS. 3A and 3B, identification member 20 is illustrated as being extendable and retractable along a plane generally parallel to front portion 18 of chassis 12 proximate to front portion 18 of chassis 12, thereby providing easy accessibility of identification member 20 to a user of system 11. However, it should also be understood that identification member 20 may be located at other positions about chassis 12 such as, but not limited to, other side or lateral locations along chassis 12 or identification member 20 may be retractable from a rearward location of chassis 12. Thus, the present invention provides for a variety of locations or positions of retractable identification member 20 relative to chassis 12.

What is claimed is:

1. A computer identification system, comprising:
an identification member retractable into an internal area of a chassis.

2. The system of claim 1, further comprising a locking element adapted to prevent removal of the identification member from the chassis.

3. The system of claim 1, wherein the chassis comprises an internally disposed pocket having an inlet for receiving the identification member.

4. The system of claim 1, wherein the chassis comprises an electromagnetically shielded pocket having an inlet for receiving the identification member.

5. The system of claim 1, wherein the identification member comprises a plurality of latch elements adapted to prevent removal of the identification member from the chassis.

6. The system of claim 1, further comprising a bezel coupled to the chassis and adapted to accommodate insertion of the identification member into the chassis.

7. The system of claim 1, wherein the identification member comprises a handle engageable by the user.

8. A retractable identification system for a computer system, comprising:
a pocket formed within an internal area of the computer system; and
an identification member extendable and retractable relative to the pocket.

9. The system of claim 8, wherein the identification member comprises a locking element adapted to prevent removal of the member from the pocket.

10. The system of claim 8, wherein the pocket comprises an electromagnetically shielded pocket.

11. The system of claim 8, wherein the identification member comprises a plurality of latch elements adapted to prevent removal of the identification member from the pocket.

12. The system of claim 8, wherein the identification member is extendable and retractable relative to a front portion of the computer system.

13. The system of claim 8, wherein the identification member comprises a handle engageable by a user of the computer system to extend and retract the identification member relative to the computer system.

14. The system of claim 8, wherein the pocket is disposed relative to the computer system to provide extension and retraction of the identification member along a plane parallel to a front portion of the computer system.

15. A computer identification system, comprising:
means for housing at least one computer component; and
means disposed within an internal area of the housing means for receiving a retractable identification member.

16. The system of claim 15, further comprising means for preventing removal of the identification member from the housing means.

17. The system of claim 15, further comprising means for electromagnetically shielding the receiving means.

18. The method of claim 15, further comprising means, formed on the identification member, for engaging the identification member by a user.

19. The system of claim 15, further comprising means for receiving the identification member via a bezel coupled to the housing means.

20. The system of claim 15, wherein the means for receiving the retractable identification member is disposed relative to the housing means to provide for extension and retraction of the identification member along a plane parallel to a front portion of the housing means.
